(19) United States
(12) Patent Application Publication
(10) Pub. No.: US 2020/0209019 A1
(43) Pub. Date: Jul. 2, 2020

(54) Detecting System Able To Generate An Electrical Signal

(71) Applicant: Brochier Technologies, 69100 Villeurbanne (FR)

(72) Inventors: Cédric BROCHIER, 69007 Lyon (FR); Delphine CHEVALIER, 26300 Chateauneuf sur Isère (FR); Emmanuel DEFLIN, 69003 Lyon (FR); Julien MORANGE, 69140 Rillieux La Pape (FR); Constance MORETTI, 69009 Lyon (FR); Jérémy PICOT-CLEMENTE, 89110 Villiers sur Tholon (FR)

(21) Appl. No.: 16/621,214

(22) PCT Filed: Jun. 13, 2018
(86) PCT No.: PCT/FR2018/051398

§ 371 Date: Dec. 10, 2019

(30) Foreign Application Priority Data
Jun. 14, 2017 (FR) 1755382

(51) Int. Cl. G01D 5/353; D03D 15/00; D03D 1/00; F21V 8/00

(52) U.S. Cl. CPC G01D 5/35341; D03D 15/0011; D10B 2401/20; G02B 6/001; D03D 1/0088

(57) ABSTRACT

Detection system for generating an electrical signal representative of a variation in light intensity, including a textile element having a first group of optical fibres including on their peripheral surface alterations allowing light to be captured laterally in at least one capturing zone of the textile element, the optical fibres of the first group being grouped together into at least one bundle on at least one border of the textile element, and at least one photosensitive element arranged facing at least one end of at least one bundle of optical fibres of the first group and allowing an electrical signal to be generated depending on the variation in light intensity captured laterally by the optical fibres in the capturing zone of the textile web.

### TECHNICAL FIELD

The invention relates to the field of detection systems interpreting variations in light intensity and allowing an electrical signal to be generated that is representative of these variations. Such detection systems can also allow the collection of solar energy at a surface and then its transmission in order to be converted into electrical energy.

The invention also relates to the field of pressure sensors. A pressing force exercised at the surface of such sensors can be detected and allow a control signal of an ancillary member to be generated. More specifically, the invention targets pressure sensors integrating detection systems allowing the generation of an electrical signal representative of a variation in light intensity.

### PRIOR ART

In general, detection systems capable of generating an electrical signal representative of a variation of light intensity, comprise a photosensitive element capable of transforming solar energy into electrical energy.

Certain detection systems can specifically integrate optical fibers each positioned in a cavity adjusted to the dimensions of the optical fiber. Deformations of the optical fiber cause a variation in the transmitted light intensity. In this case, it is possible to equip one of the ends of the optical fiber with a light source, and the other end of the optical fiber with a photosensitive element. Such a device type then forms a pressure sensor as disclosed specifically in document FR-2 672 681.

However, this type of device is complicated to embody and only allows identifying the intensity of an effort on the surface of this sensor. Therefore, it does not allow locating the exact position the application of the effort on the surface of the sensor.

In order to overcome this disadvantage, document WO 00/73982 envisions and describes positioning two sections of optical fibers, in parallel, inside a cavity adjusted to the dimensions of the two sections of optical fibers. A first section of optical fiber is connected to a light source while the other section of optical fiber is connected to a photosensitive element. In this case, the pressure of a user's finger proximate to the free ends of the sections of optical fibers makes it possible to bring these ends close together and to thus increase the amount of energy transmitted between the first section and the second section.

However, this type of sensor is complicated to manufacture and requires the manual positioning of the various fibers inside cavities. Thus, such a device is not suitable for generating a significant number of distinct capturing zones, as well as zones of large dimensions and, specifically, greater than one square meter.

Thus, a purpose of the invention is to facilitate the manufacture of detecting systems, of sensors, specifically of pressure sensors, comprising optical fibers and capable of generating an electrical signal representative of a variation in light intensity.

### DISCLOSURE OF THE INVENTION

Therefore, the invention concerns a detection system capable of generating an electrical signal representative of a variation in light intensity.

It s characterized in that it consists of:
a textile element comprising a first group of optical fibers including on their peripheral surface alterations al lowing light to be captured laterally the first group being grouped together into at least one bundle on at least one border of the textile element;
at least one photosensitive element arranged facing at least one end of at least one bundle of optical fibers of the first group and allowing an electrical signal to be generated as a function of the variation in light intensity-captured laterally by the optical fibers in said capturing zone of the textile element.

In other words, the optical fibers are arranged inside a textile element which may have ancillary threads allowing to secure optical fibers in a predetermined position in relation to each other. In this way, the optical fibers can be arranged substantially parallel to each other and to present a cohesion facilitating their handling, as well as their positioning in an ancillary device wherein the detection system can be positioned.

Furthermore, the optical fibers comprise alterations which may consist of roughening of the outer surface of each one of the fibers. These alterations can also be made by incisions allowing the transmitting to the interior of the optical fibers of a light beam, natural or artificial, occurring at the peripheral surface of the optical fibers. It is also possible to generate the alterations by a thermal or chemical treatment applied to the optical fibers.

The optical fibers are then grouped together into at least one bundle at one border of the textile element so that the ends of the optical fibers can be arranged facing a photosensitive element, for example a photodiode. The light captured by the lateral surface of the optical fibers is therefore transmitted from at least one of their ends to the photosensitive element.

According to one variant, this photosensitive element can be a photovoltaic cell. Thus, it is possible to embody photovoltaic systems integrating one or more of these textile elements for the production of electricity.

In practice, all or part of the optical fibers of the textile element can be covered with a coating layer of a material with adaptive optical properties, specifically as a function of the ambient environment. For example, it is possible to choose materials having the capacity to change coloration (color, opacity, transparency . . . ) under the effect of a stimulus (light, temperature, pressure, humidity, etc.). Thus, it is, for example, possible to embody detecting devices that vary with the ambient environment, such as, for example, a meteorological variation.

According to a specific embodiment, the textile element may comprise a second group of optical fibers including on their peripheral surface alterations allowing the lateral emission of light in at least one emission zone arranged in immediate proximity of the capturing zone of the first group of optical fibers with the optical fibers of the second group being grouped together into at least one bundle on at least one border of the textile element. The detection system may, additionally, comprise at least one light source arranged facing the ends of the bundle of optical fibers of the second group and allowing the emission of a light signal inside of the bundle. The detecting system may also be coupled to an external light source.

In other words, the textile element comprises two groups of optical fibers, one allowing the lateral emission of light and the other allowing the capture of the emitted light.

One possible application of such a detecting system may be the detection of presence. Thus, when a user positions an object, or a part of his body, in contact with, or in immediate proximity to, the detecting system, light is reflected on the object, then captured by the first group of optical fibers. This reflection of light therefore generates a variation in light intensity captured by the first group of optical fibers.

To do this, the light source may use a type of light beam presenting a predetermined wave length and, as a result, it may not be influenced by external radiation such as solar radiation or the radiation generated notably by the lighting means of a room.

It is also possible to envision the use of such a textile element for the manufacturing of a wireless communications system known by the acronym LiFi (acronym for “Light Fidelity”) based on the use of visible light. The principle of LiFi relies on the coding and sending of data via amplitude or frequency modulation of light sources according to a well-defined and standardized protocol. Thus, it is possible to send and/or receive data via capturing and emission zones arranged in the textile element.

In practice, the textile element can be a fabric having, in warp and/or in weft, optical fibers from the first group of binding threads arranged in warp and/or in weft.

Thus, the optical fibers are woven with binding threads which make it possible to hold the optical fibers in position in relation to each other within the textile element. According to one variant, all or part of the binding threads may be elastic.

Advantageously, the fabric may comprise the optical fibers of the second group in warp and/or in weft. In this case, it is possible to position, in parallel and alternatively, an optical fiber of the first group alongside of an optical fiber of the second group, and this throughout the surface of the fabric.

The invention also relates to a pressure sensor comprising a detection system as previously disclosed and:
a second textile element comprising another group of optical fibers including on their peripheral surface alterations al lowing the lateral emission of light in at least one emission zone arranged facing the capturing zone of the first group of optical fibers of the textile element, the optical fibers of the other group being grouped together into at least one bundle on at least one border of the textile element;
a light-permeable layer arranged between the two textile elements and capable of elastically deforming in order to enable the two elements to come closer from each other, when an effort is applied to the pressure sensor.

Advantageously, the pressure sensor may be coupled to an external light source or can integrate an internal light source. Thus, according to one embodiment, the pressure sensor may also comprise at least one light source arranged facing one end of the bundle of optical fibers of the other group and allowing the emission of a light signal inside the bundle.

In other words, such a pressure sensor comprises both a detection system having a first textile element integrating a first group of optical fibers to capture light, and a second textile element integrating another group of optical fibers to emit light to inside the pressure sensor. Preferably, the first textile element, the permeable layer and the second textile element are arranged in layers, wherein the permeable layer is positioned between the two textile elements and has elasticity properties so as to allow the return to position of the textile element that is displaced once the effort is removed. Thus, when a person or an object exercises an effort on the surface of the pressure sensor, the latter brings the two textile elements closer together and thus improves light transmission. This then causes an increase in light intensity sensed by the photosensitive element arranged at the end of the optical fibers of the first group.

The degree of transparency or opacity of the permeable layer may specifically, be modulated as a function of the detection precision that it is desired to provide to the system. It is understood, for example, that a translucent layer will allow more light to pass between the two textile elements at the time these two textile elements are brought closer to each other resulting from pressure exercised on one of these textile elements.

For example, it is possible to use a permeable layer of translucent material comprising fillers capable of varying the opacity of the permeable layer as a function of the pressure applied to one of the textile elements, and therefore, to vary the amount of light passing between the two textile elements.

In practice, the light permeable layer can be obtained in different ways and, notably, be constituted by an ancillary material positioned between the two textile elements, or even by an element of one of the textile elements, that is, threads or a coating layer.

Thus, according to a first embodiment, the light-permeable layer can be formed by a foam sheet. In this case, the foam sheet constitutes an independent element inserted between the two textile webs or even a coating layer for one of the two textile elements.

According to a second embodiment, the light-permeable layer can be formed by binding threads belonging to at least one of the two textile elements. These binding threads can, for example, have a diameter greater than that of the optical fibers of the first and/or the other group.

According to a third embodiment, the permeable layer can be obtained by three-dimensional OD) knitting or weaving which makes it possible to connect the two textile elements and to create an air-filled hollow gap between two binding threads that are remote from each other. The upper textile element, namely, the one intended to have an effort applied to it, is therefore capable of moving toward the inside of the air-filled gap arranged between the two binding threads. The 3D knitting or weaving can be done using ancillary threads or by directly using all or part of the binding threads for the optical fibers.

According to a particular embodiment, the light source can emit within or outside of the visible spectrum, for example, infrared light beams, so that solar radiation, as well as radiation from an indoor light, does not influence the variation of light intensity detected by the photosensitive element.

The invention also relates to another type of detection system capable of generating an electrical signal representative of a variation in light intensity.

In this case, it is characterized in that it comprises:
a textile element comprising a plurality of optical fibers including on their peripheral surface alterations allowing the lateral emission of light in at least one emission zone and wherein they are sensitive to reflection when an object tends toward contact with said alterations, wherein the optical fibers are grouped together into at least one bundle on at least one border of the textile element;
at least one photosensitive element arranged facing an end of the bundle of optical fibers positioned at one border of the textile element, wherein the photosensitive element makes it possible to generate an electrical signal as a function of the variation in light intensity transmitted by the optical fibers.

The detecting system may further comprise at least one light source arranged facing one end of the bundle of optical fibers positioned at a first border of the textile element and allowing the emission of a light signal inside of said optical fibers. The detecting system may also be coupled to an external light source.

In other words, the alterations made to the optical fibers al low both the emission of light at the emission zone, but also the reflecting of light when an object is positioned in contact with, or in proximity to, the optical fibers so as to locally mask the emission zone. Thus, when an object masks a part of the emission zone of the fibers, the light intensity sensed by the photosensitive element is greater than when no object reflects the emitted light.

In the same way as previously, the autonomous light source can emit within or outside of the visible spectrum, for example infrared light beams, in order to render the detecting system insensitive to external light such as sunlight or that from artificial lighting.

In the same way as previously, the textile element can be a fabric having in the warp and/or the weft optical fibers of the first group and binding threads arranged in the warp and/or in weft. In addition, all or part of the binding threads can be elastic. Furthermore, the optical fibers can also be coated by a coating layer in a material with adaptive optical properties.

Of course, for all of the embodiments presented previously, the arrangement of the set of optical fibers will depend on the chosen application. Thus, a large number of configurations can be foreseen, such as, for example, an arrangement in a matrix of emission and/or capturing zones, or even according to a particular design.

In practice, the textile element comprising the fibers can have different forms, for example, the form of a textile web, or any textile element obtained for example by a weaving, knitting, embroidery, braiding, etc. method, and optionally shaped so as to form a 3D structure. Such a 31) structure can for example be in the form of a cylinder thus forming a light guide.

### BRIEF DESCRIPTION OF THE FIGURES

The manner of embodying the invention as well as the resulting advantages, will emerge from the disclosure of the embodiment that follows, given by way of a non-limiting example, supported by the figures wherein:

FIGS. 1 to 9 schematically represent detection systems capable of generating an electrical signal representative of a variation in light intensity generated by an external source such as a lamp or the sun.

FIGS. 10, 11, 12, 13A and 13B schematically represent detection systems capable of generating an electronic signal representative of a variation in light intensity and wherein the light source is integrated into the same textile web with the capturing means.

FIGS. 14A, 14B and 15A, 15B schematically represent pressure sensors comprising a capturing system as disclosed in FIGS. 1 to 9.

### METHOD FOR IMPLEMENTING THE INVENTION

As already stated, the invention relates to a detection system capable of generating an electrical signal representative of a variation in light intensity.

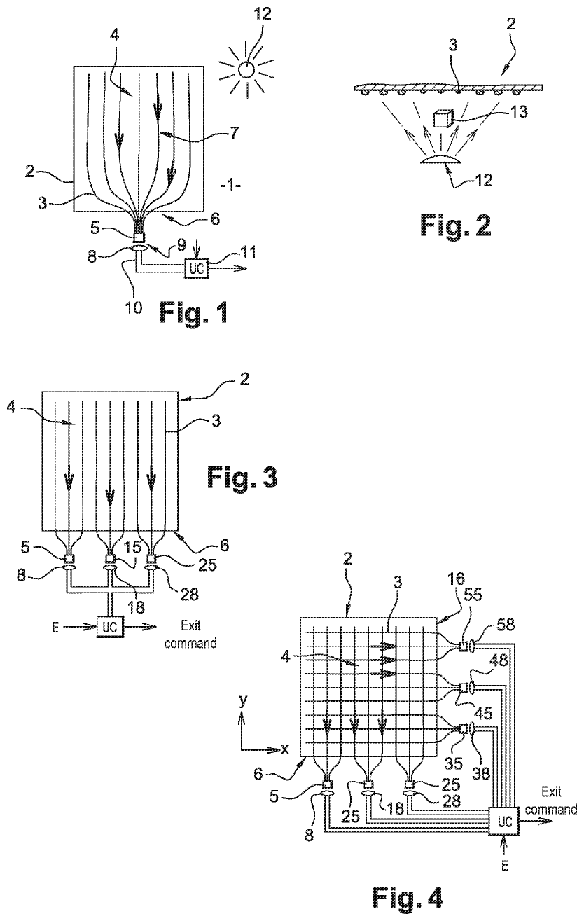

Such a detection system can be included in different devices or sensors. Thus, as depicted in FIGS. 1 to 9, such detection systems can be used in order to detect a shadow on their surface.

To do this, and as depicted in FIG. 1, the detection system 1 comprises a textile element, for example a textile web or sheet 2 in this particular embodiment, inside which optical fibers 3 are arranged making it possible to capture the light emitted by an external source such as the sun 12 in at least one light capturing zone 4. Therefore, such optical fibers 3 have alterations on their peripheral surface so as to laterally capture light. The optical fibers 3 belong to a first group and emerge from the textile web 2 at an edge or border 6 to be grouped together into a bundle 5.

One end 9 of the bundle 5 is then positioned facing a photosensitive element 8 making it possible to convert into electrical energy the beam captured by the optical fibers. The electrical signal can then be transmitted by wire 10 to a control unit 11 in order to then generate a control signal that can be analyzed, or even be used to control motorized means, or even an information display member.

As depicted in FIG. 2, when an object 13 is interposed between the textile web 2 and the light source 12, a shadow zone is detected by the optical fibers 3 and it is then possible to detect the variation in light intensity generated by the object 13.

As depicted in FIG. 3, the optical fibers 3 can be grouped together into several bundles 5, 15, 25 of optical fibers and can thus generate different zones for capturing 4, 14, 24 light. These zones are defined using the different bundles 5, 15, 25 of optical fibers and can, as a result, be arranged parallel over the whole surface of the textile web 2. The different bundles emerge from the textile web at an edge 6 and are facing several photosensitive elements 8, 18, 28 which are, themselves, connected to a control unit.

As depicted in FIG. 4, the optical fibers 3 can be arranged in both warp and/or weft within the textile web 2 which is, in this particular case, a fabric. This particular arrangement then makes it possible to determine the position by abscissa and ordinate of the shadow of an object projected oil the textile web. The bundles of optical fibers 5, 15, 25, thus emerge at a first edge 6 while the bundles of optical fibers 35, 45, 55, emerge at a second edge 16 of the textile web. Such a capturing system may specifically be used to measure the movements of an object on its surface and be inserted into a floor covering making it possible to cover a hall or room through which people pass or move.

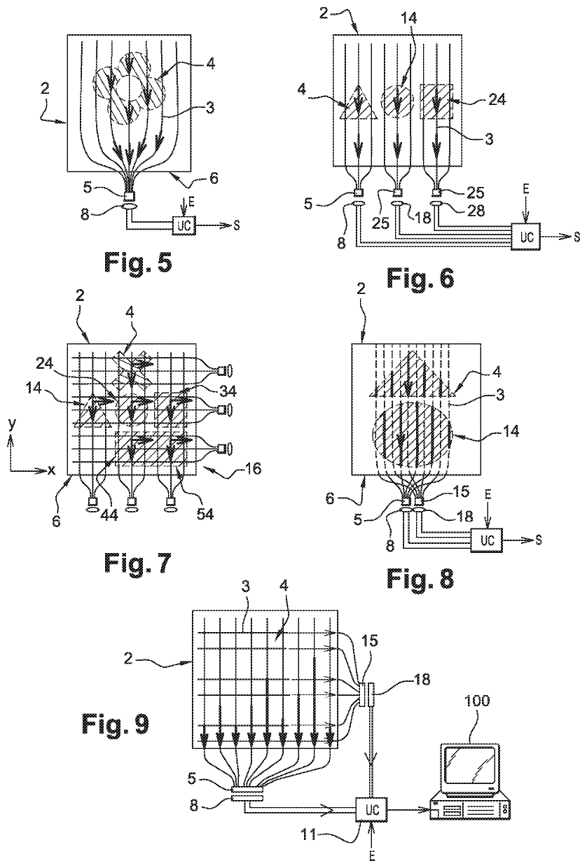

As depicted in FIG. 5, the optical fibers 3 of the textile web 2 can have alterations positioned only at a light capturing zone 4, which has a particular geometric form. In this case, the light capturing zone 4 does not extend over the entirety of the textile web 2 and is therefore localized.

Likewise, and as depicted in FIG. 6, a textile web 2 can have several light capturing zones 4, 14, 24 delimited by particular shapes corresponding to the position of the alterations generated on the peripheral surface of the optical fibers 3. Thereafter, by using, for example, three bundles of optical fibers 5, 15, 25, it is possible to complete, in this particular case, the analysis of the presence or absence of the shadow of an object at the three light capturing zones 4, 14, 24.

Thus, as depicted in FIG. 7, by using several bundles of optical fibers emerging from two edges 6, 16 of the textile web 2, it is possible to embody a multitude of light capturing zones 4, 14, 24, 34, 44, 54, delimited by the positioning of the alterations on the optical fibers. Such an embodiment allows notably to embody keyboard type devices, or any control member pre-equipped with keys.

Finally, in the variation depicted in FIG. 8, it is possible to execute at least two light capturing zones 4, 14 located on the optical fibers emerging from a single edge 6 of the textile web 2. To do this, the textile web 2 can be made by a Jacquard weaving process, wherein it is possible to position the optical fibers at different depths as a function of their connection bundle 5, 15. Thus the optical fibers belonging to the bundle 5 are flush with the capturing zone 4 and can be processed so as to generate alterations only on the optical fibers of these bundles 5. The optical fibers are then positioned at the lower face of the textile web 2 and are not therefore processed at the capturing zone 14. Likewise, the optical fibers belonging to the bundle 15 are then positioned at the upper face of the textile web 2 in the capturing zone 14, then positioned at the lower face of the textile weblayer 2 in the capturing zone 4.

As depicted in FIG. 9, it is also possible to use photosensitive elements 8, 18 capable of detecting variations in light intensity of each optical fiber belonging to the same bundle 5, 15 positioned at the edge of the textile web 2. In this way, the photosensitive element has a plurality of pixels illuminated by one or more optical fibers and processing by a computerized system 100 then makes it possible to know the exact position of an object on the surface of the textile web 2, in the same way as with the capturing system illustrated in FIG. 4, but with only one bundle 5, 15 of optical fibers at two edges of the textile web.

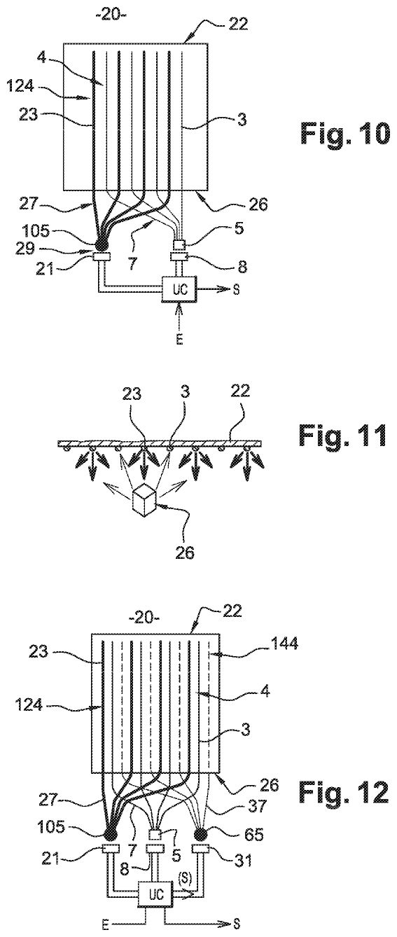

As depicted in FIG. 10, a capturing system 20 can also comprise a second group 27 of optical fibers 23 comprisitalterations at their peripheral surface so as to emit light at an emission zone 24. This emission zone 124 is arranged proximate to the capturing zone 4 of the optical fibers 3 of the first group 7.

Furthermore, a light source 21 which can be autonomous or not, is arranged facing the end 29 of a bundle 105 of optical fibers belonging to the second group 27. As represented, the optical fibers 3, 23 can be arranged parallel to the textile web 22 and emerge at a same edge 26 in order to facilitate their connection with, on one hand, the light source 21 and, on the other hand, the photosensitive element 8.

Thus, as depicted in FIG. 11, when an object 26 is positioned proximate to or in contact with the textile web 22, the latter reflects the light emitted by the optical fibers 23 and therefore generates a localized increase in the light captured by the optical fibers 3. Therefore, such a detecting system makes it possible to embody a reflective object sensor 26. In fact, certain objects cannot reflect the light emitted by the optical fibers 23 and are therefore not identifiable by the detecting system.

As depicted in FIG. 12, the detecting system 20 can also have optical fibers having alterations at their periphery for emitting visible light from the textile web 22. This light emitting zone 144 is also arranged in the immediate vicinity of the capturing zone 4 and makes it possible to inform a user that the capturing of the variation of light intensity at the textile web 22 was indeed completed by the photosensitive element 8 and processed by the control unit.

These illuminating optical fibers also form a group 37 of optical fibers connected as a bundle 65 at the edge 26 of the textile web 22. This bundle 65 is facing another light source generating, for example, light beams within the visible spectrum.

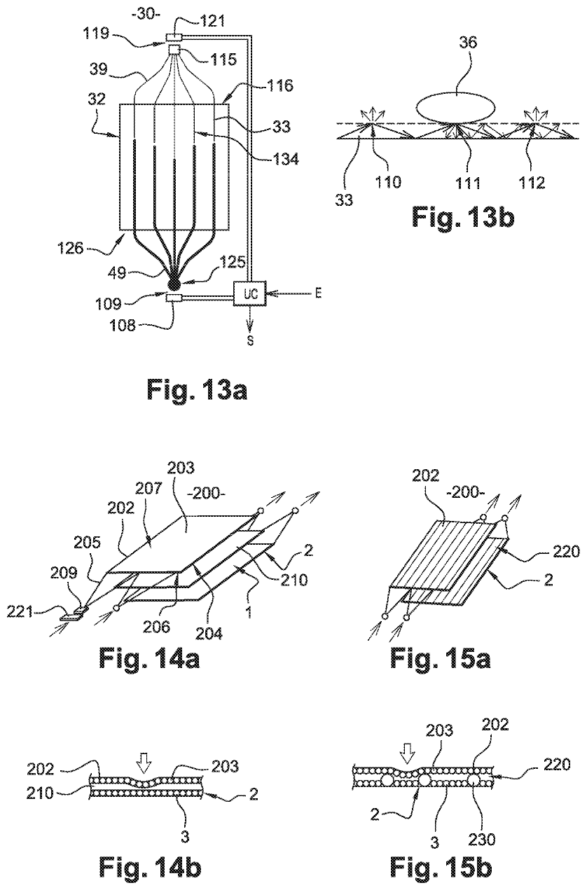

As depicted in FIG. 13A, the detection system 30 can also be embodied using a textile web 32 wherein the optical fibers 33 make possible both the emitting of light at the alterations and the reflecting of light when an object covers the external surface of the textile web 32. As a result, each end 39, 49 of the optical fibers 33 has a bundle 115, 125 arranged on opposite edges 116, 126. The end 119 of the bundle 115 is facing a light source 121. Furthermore, the end 109 of the bundle 125 is facing a photosensitive element 108 capable of detecting a variation in the light energy transmitted by the optical fibers and optionally reflected by an object at the emitting zone 134 of the optical fibers 33.

In one variant of the embodiment illustrated in FIG. 13A, it is possible to replace the light source 121 with another photosensitive element. In this variant, the detection system will thus comprise two photosensitive elements arranged facing ends 39, 49 of optical fibers grouped together in bundles 115, 125. Thus, this system offers the ability to detect environmental light, to localize the light on the textile web, to determine a variation in the light, to determine the presence of an object or the application of a mechanical deformation.

As depicted in FIG. 13B, the object 36 can notably be formed by a user's finger. Such a finger then makes it possible to mask the alteration 111 of the optical fiber 33 while the alterations 110 and 112 make it possible to emit light to the surroundings.

As depicted in FIG. 14A, the capturing system 1 can be integrated into the interior of a pressure sensor 200. In this case, a second textile element in the form of a second textile web 202 is arranged parallel to the textile web 2 of the detecting system 1. Such a second textile web 202 comprises optical fibers 203 belonging to another group 207. These optical fibers 203 are capable of emitting light laterally thanks to alterations of the periphery of their surface. At one edge 206, the optical fibers 203 are grouped together in bundles 205 the end 209 of which is facing a light source 221.

Furthermore, a light permeable layer 210 is positioned against the two textile webs 2, 202 so as to enable a closing up when an effort is applied to the surface of one of the two textile webs. Thus, the pressure sensor 200 is obtained by improving the light transmission when the two textile webs are proximate to each other. As a result, the light permeable layer 210 must have elasticity in order to ensure the return to initial position of the textile web that was displaced. In other variants, the permeable layer can be filled with opaque material, capable of increasing the opacity of the permeable layer when a pressure is exercised on one of the textile webs.

As depicted in FIG. 14B, this light permeable layer 210 can be formed by a foam sheet with open or closed cells, capable of returning to its resting position when no effort is applied to the surface of the textile web 202. This foam sheet can be independent, or can even be a coating layer of one of the two textile webs 2, 202.

Furthermore, and as depicted in FIG. 15A, the translucent light permeable layer 220 can be formed by binding threads 230 belonging to at least one of the two webs 2, 202.

As depicted in FIG. 15B, a gap 231 is defined between two binding threads 230 in order to allow bringing closer the two textile webs 2, 202 when an effort is applied. This spacing can, for example, be executed by 3D weaving or knitting using ancillary threads or binding threads of the optical fibers.

It results from the above that a capturing system and a pressure sensor according to this invention have many advantages, and in particular:
they allow to facilitate the manufacture of capturing devices by automatically generating, as in weaving, a large capturing zone;
they are, therefore, especially adapted to environments with large surfaces
they can be provided in diverse shapes and have an optical capturing interface remoted from the electrical conversion system, for example of several meters distant, the optical capturing surface being furthermore able to be custom-cut.
They provide the ability through the same media to combine the functions of detection and visual notification of this detection, whereupon the sensor illuminates when the information is transmitted.

1. Detection system k for generating an electrical signal representative of a variation in light intensity, characterized in that it comprises:
a textile element comprising a first group of optical fibers including on their peripheral surface alterations allowing light to be captured laterally in at least one capturing zone of the textile element, the optical fibers of the first group being grouped together into at least one bundle on at least one border of the textile element;
at least one photosensitive element arranged facing at least one end of at least one bundle of optical fibers of the first group and allowing the generation of an electrical signal as a function of the variation in light intensity captured laterally by the optical fibers in said capturing zone of the textile web.

2. Detection system according to claim 1, characterized in that the textile element comprises a second group of optical fibers comprising on their peripheral surface alterations allowing the lateral emission of light in at least one emission zone arranged in immediate proximity to the capturing zone of the first group of optical fibers with the optical fibers of the second group being grouped together into at least one bundle on at least one border of the web;
and in that the detecting system comprises at least one light source arranged facing one end of the bundle of optical fibers of the second group and allowing the emission of a light signal inside of said bundle.

3. Detection system according to claim 1, characterized in that the textile element can be a fabric having optical fibers in the warp and/or the weft of the first group and binding threads arranged in warp and/or in weft.

4. Detection system according to claim 2, characterized in that the fabric comprises, in warp and/or in weft, the optical fibers the second group.

5. Pressure sensor characterized in that it comprises a detection system according to claim 1 and:
a second textile element comprising another group of optical fibers comprising on their peripheral surface alterations allowing the lateral emission of light from at least one emission zone arranged facing the capturing zone of the first group of optical fibers of the textile web, the optical fibers of the said other group being grouped together into at least one bundle on at least one border of the second textile element;
a light-permeable layer between the two textile elements and capable of elastically deforming in order to enable a closing together of the two textile elements when an effort is applied to said pressure sensor.

6. Pressure sensor according to claim 5, characterized in that it comprises at least one light source arranged facing one end of the bundle of optical fibers of said other group and allowing the emission of a light signal inside of said bundle.

7. Pressure sensor according to claim 5, characterized in that the light permeable layer is formed by a foam sheet.

8. Pressure sensor according to claim 5, characterized in that the light permeable layer is formed by binding threads belonging to the at least one of the two textile webs.

9. Pressure sensor according to claim 5, characterized in that the light permeable layer is a 3D knitted layer.

10. Pressure sensor according to claim 5, characterized in that the light source emits non-visible light beams.

11. Detection system for generating an electrical signal representative of a variation in light intensity, characterized in that it comprises:
a textile element comprising a plurality of optical fibers comprising on their peripheral surface alterations allowing the lateral emission of light in at least one emission zone and wherein they are sensitive to reflection when an object tends toward contact with said alterations wherein the optical fibers are grouped together at each end into at least one bundle on at least one border of the web;
at least one photosensitive element arranged facing an end of the bundle of optical fibers positioned at a second border of the textile web, wherein said photosensitive element allow to generate an electrical signal as a function of the variation in light intensity transmitted by the optical fibers.

12. Detection system according to claim 11, characterized in that it further comprises at least one light source arranged facing one end of the bundle of optical fibers positioned at another border of the textile web and allowing the emission of a light signal inside of said optical fibers.

13. Detection system according to claim 12, characterized in that the autonomous light source emits light beams from the non-visible spectrum.

14. Detection system according to claim 2, characterized in that the autonomous light source emits light beams from the non-visible spectrum.
